(19) United States
(12) Patent Application Publication
(10) Pub. No.: US 2011/0247007 A1
(43) Pub. Date: Oct. 6, 2011

(54) OPERATORS WITH REQUEST-RESPONSE INTERFACES FOR DATA STREAM PROCESSING APPLICATIONS

(75) Inventors: Henrique ANDRADE, Croton-on-Hudson, NY (US); Bugra GEDIK, White Plains, NY (US); Nagui HALIM, Yorktown Heights, NY (US); Martin J. HIRZEL, White Plains, NY (US); Vibhore KUMAR, Stamford, CT (US); Kun-Lung WU, Yorktown Heights, NY (US)

(73) Assignee: INTERNATIONAL BUSINESS MACHINES CORPORATION, Armonk, NY (US)

(21) Appl. No.: 12/752,265

(22) Filed: Apr. 1, 2010

(51) Int. Cl. G06F 9/46

(52) U.S. Cl. 719/313

(57) ABSTRACT

Processing streaming data in a data processing system is facilitated by: declaring and defining, by a processor, a request-response interface as part of a stream processing operator defined using a stream processing language; processing a stream of data using the stream processing operator with the request-response interface defined as a part thereof; and communicating with the stream processing operator through the request-response interface via a communication path separate from the stream of data, the communicating accessing or controlling a state of the stream processing operator while the stream processing operator is processing the stream of data.

This invention was made with Government support under Contract No. H98230-07-C-0383, awarded by Intelligence Agencys. The Government has certain rights in this invention.

### BACKGROUND

This invention relates in general to processing streaming data, and in particular, to facilitating enhanced processing of such data.

Processing within a data processing system can include various forms, including non-stream processing and stream processing. In non-stream processing, data is received, saved and later processed. In contrast, in stream processing, data is processed, as it is continuously received.

Examples of stream processing systems include large scale sense-and-respond systems, which continuously receive external signals in the form of one or more streams from multiple sources and employ analytics aimed at detecting critical conditions and, ideally, responding in a proactive fashion. Examples of such systems abound, ranging from systems deployed for monitoring and controlling manufacturing processes, power distribution systems, and telecommunication networks, to environmental monitoring systems, to algorithmic trading platforms, etc. These sense-and-respond systems share the need for:
(1) calculating baselines for multiple samples of incoming signals (e.g., instantaneous electricity production levels, the fair price of a security, among others); and/or
(2) correlating the computed value for a signal with other signals (e.g., instantaneous electricity consumption levels, the ask price of a security, among others).

This paradigm of streaming analytics focuses on incremental processing as data is received from external sources. This differs from the typical store-and-process paradigm (e.g., non-stream processing) that answers queries by processing the needed data for that query at the time the query is issued. The advantage of incremental processing is the availability of analysis results with low latency and high throughput.

### BRIEF SUMMARY

In accordance with an aspect of the present invention, a method of processing streaming data in a data processing system is provided which includes: defining, by a processor, a request-response interface as part of a stream processing operator defined using a stream processing language, wherein the stream processing operator is a processing component that processes a data stream as continuously received, and the request-response interface is a non-streaming interface; processing a stream of data using the stream processing operator with the request-response interface defined as a part thereof; and communicating with the stream processing operator through the request-response interface via a communication path separate from the stream of data, the communicating at least one of accessing or controlling a state of the stream processing operator while the stream processing operator is processing the stream of data.

In another aspect, a computer program product for processing streaming data in a data processing system is provided. The computer program product includes a computer readable storage medium for execution by at least one processor for performing: defining, by the at least one processor, a request-response interface as part of a stream processing operator defined using a stream processing language, wherein the stream processing operator is a processing component that processes a data stream as continuously received, and the request-response interface is a non-streaming interface; processing a stream of data using the stream processing operator with the request-response interface defined as a part thereof; and communicating with the stream processing operator through the request-response interface via a communication path separate from the stream of data, the communicating at least one of accessing or controlling a state of the stream processing operator while the stream processing operator is processing the stream of data.

In a further aspect, a computer system is provided for processing streaming data. The computer system includes a processor for processing a stream of data using a stream processing operator with a request-response interface defined as a part thereof, wherein the stream processing operator is a processing component that processes a data stream as continuously received, and the request-response interface is a non-streaming interface. Another stream processing operator or a running application communicates with the stream processing operator through the request-response interface via a communication path separate from the stream of data. The communicating results in at least one of access to or control of a state of the stream processing operator while the stream processing operator is processing the stream of data.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a data processing system to incorporate and use one or more aspects of the present invention;

FIG. 2 depicts compiling a stream processing language program which includes multiple stream processing operators, one or more of which include a request-response interface, and illustrating use of request-response client-side interfaces to allow interaction from one or more other stream processing operators and/or one or more client applications to the stream processing operator(s) via its respective request-response interface, in accordance with an aspect of the present invention;

FIG. 3 depicts one embodiment of a process to declare and define a request-response interface for a stream processing operator, in accordance with an aspect of the present invention;

FIG. 4 depicts one embodiment of a process for employing a request-response interface defined for a stream processing operator, in accordance with an aspect of the present invention;

FIG. 5 depicts one embodiment of a process for invoking a request-response method of a stream processing operator with a request-response interface, wherein the invoking is from another stream processing operator of the data processing system via the request-response interface thereof, in accordance with an aspect of the present invention;

FIG. 6A is an example of a stream processing operator with a request-response interface, wherein the operator receives a stream of data comprising edges of a social network graph as input and manages the edges internally in the form of an internal social network graph, and wherein the request-response interface is accessible via a separate communication path for interacting with the operator from, for example, another operator of the data processing system or a running application of the data processing system, in accordance with an aspect of the present invention;

FIG. 6B depicts the stream processing operator of FIG. 6A, with another stream processing operator of the data processing system shown communicating therewith through the request-response interface, which is employed by the another operator to access a getTopKEdges method of the stream processing operator, the top K edges being employed by the another stream processing operator, in accordance with an aspect of the present invention;

FIG. 6C depicts an example of a running application interacting with the request-response interface of the stream processing operator of FIG. 6A, again via a separate communication path from the streaming data being processed, in accordance with an aspect of the present invention; and

FIG. 7 depicts one embodiment of a computer program product incorporating one or more aspects of the present invention.

### DETAILED DESCRIPTION

While stream processing solutions are well suited for processing rapidly incident streams of data/events, available solutions fail to address the need for enabling request-response-type communication with a stream processing operator while a stream of data is being processed by the operator. Conventionally, data streams are the only path for communicating with a stream processing operator. Thus, one approach to communicating with a stream processing operator is to emulate a blocking request-response interaction within the data stream itself. Unfortunately, this approach is extremely cumbersome, inefficient and error-prone.

Disclosed herein therefore are stream processing operators augmented with remotely accessible request-response interfaces accessible through a different communication path than the stream of data. Such stream processing operators, alternatively referred to herein as request-response stream processing operators, comprise a request-response interface as a part of the stream processing operator defined using a stream processing language. Advantageously, a request-response interface such as disclosed herein can be employed in accessing, modifying or otherwise controlling a control state associated with the stream processing operator. By way of example, a load shedding operator might have a load shedding factor used as a control, the state of which could be updated based on a load prediction by an external entity. Additionally, a request-response interface such as disclosed herein might be employed to access, modify or otherwise control a logical state associated with a request-response stream processing operator. As one example of this, in a graph mining application, where parts of a rapidly evolving large social network graph are maintained and manipulated by several operators, request-response interfaces integrated with the several operators storing sub-graphs allows for efficient logical state queries against the complete social network graph being maintained internally by the operators.

In accordance with an aspect of the present invention, a capability is thus provided for improving processing of streaming data by declaring and defining, by a processor, a request-response interface as part of a stream processing operator defined using a stream processing language. Subsequently, during processing of a stream of data using the stream processing operator, communicating with the stream processing operator through the request-response interface is possible via a communication path separate from the stream of data. This separate communication allows interaction with an internal state of the stream processing operator while the stream processing operator is processing the stream of data. For example, another stream processing operator or a running application of the data processing system may interact with the request-response stream processing operator through the request-response interface thereof to ascertain, manipulate, modify, control, create, etc., at least one of a control state or a logical state of the stream processing operator while the stream processing operator is processing the streaming data.

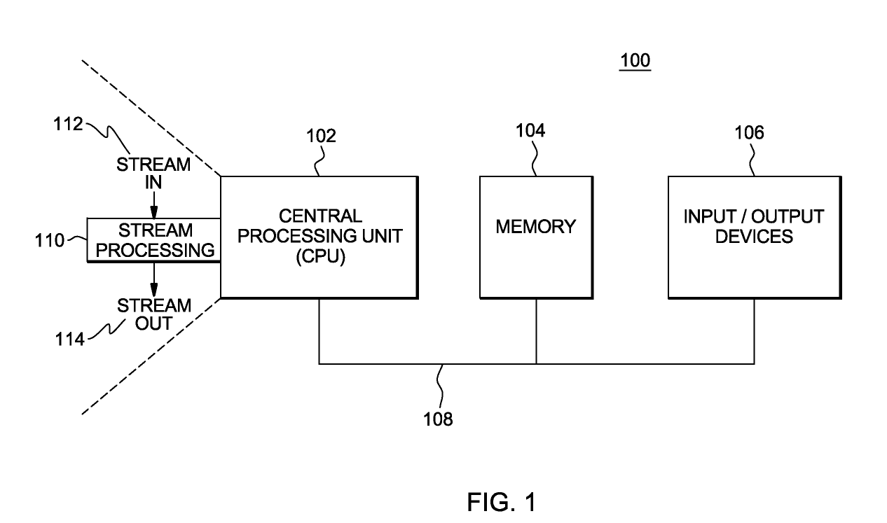

One embodiment of a data processing system to incorporate and use one or more aspects of the present invention is described below with reference to FIG. 1. As one example, the data processing system may comprise a high performance computing system that rapidly analyzes information as it streams from thousands of real-time sources. As an example, the data processing system employs IBM's InfoSphere Streams™ stream processing middleware, which enables continuous and extremely fast analysis of massive volumes of information-in-motion to help improve business insights and decision making. InfoSphere Streams™ supports high volume, structured and unstructured streaming data sources, such as images, audio, voice, VoIP, video, tv, financial news, radio, police scanners, web traffic, e-mail, chat, GPS data, financial transaction data, satellite data, sensors, badge swipes, etc. Further details on IBM's InfoSphere Streams™ are provided in various IBM publications including, for example, a publication entitled “IBM InfoSphere Streams, Redefining Real Time Analytics”, by Roger Rea and Krishna Mamidipaka, published February, 2010.

In the example of FIG. 1, data processing system 100 includes, for instance, a processor 102 (e.g., a central processing unit (CPU)), a memory 104 (e.g., main memory), and one or more input/output (I/O) devices 106, coupled to one another via, for example, one or more buses 108. As an example, processor 102 is an x86 processor offered by Intel® Corporation, Santa Clara, Calif. Processor 102 may execute an operating system, as well as applications or logic to perform one or more tasks. In one example, processor 102 executes stream processing logic 110 to implement one or more aspects of the present invention. Intel® Corporation is a registered trademark of Intel® Corporation, Santa Clara, Calif., U.S.A. Other names used herein may be registered trademarks, trademarks or product names of International Business Machines Corporation or other companies. In embodiments of the invention, stream processing logic may comprise a group of operators, each of which may be software that executes on a processor such as processor 102 to perform one or more stream processing functions, including providing an output stream to a next operator. As shown in FIG. 1, an input stream of events 112 may be provided to stream processing logic 110, which may output a stream of events 114. As one example, the stream of events may comprise a stream of edges belonging to a social network graph, such as communication edges, each edge defining a communication from one entity (e.g., a cell phone number) to another entity.

As noted, in embodiments disclosed herein, one or more of the stream processing operators 110 may be a request-response stream processing operator with a request-response interface which allows interaction with the request-response stream processing operator (while the stream processing operator is processing a stream of data) to, for example, ascertain or control a state of the request-response stream processing operator.

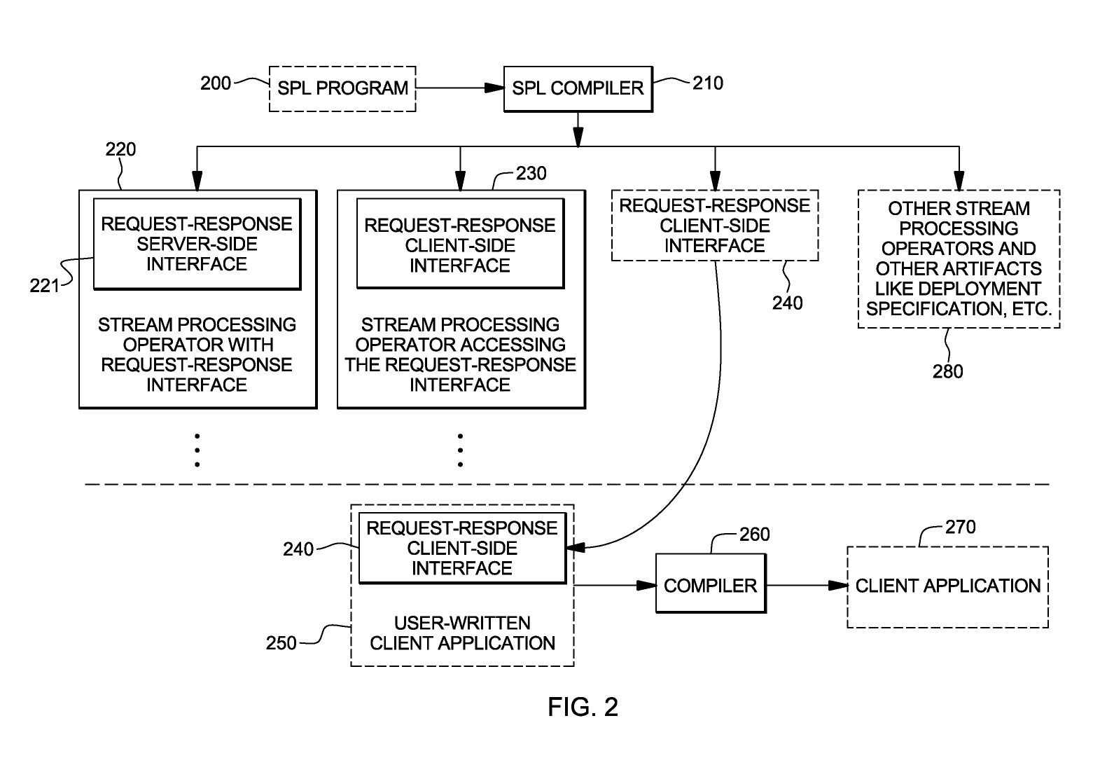

FIG. 2 illustrates one example of compile time processing for compiling one or more stream processing operators within a stream processing language program. As one example, the stream processing language might comprise the SPL programming language, which is described in an IBM Research Report entitled “SPL Stream Processing Language Specification”, indexed as RC 24897, dated Nov. 5, 2009. Also, reference “Spade: The System S Declarative Stream Processing Engine”, GEDIK et al., Sigmod '08, Jun. 9-12, 2008, pp. 1123-1134. In accordance with an aspect of the present invention, one or more request-response interfaces are written into the stream processing language program 200 using, in one embodiment, the stream processing language itself. A stream processing language compiler 210 then compiles the stream processing language program into an executable program containing request-response stream processing operators 220 with request-response interfaces, labeled request-response server-side interfaces 221 through which one or more operator methods may be remotely called and processed via a communication path separate from the streaming data to be processed by the compiled program. For example, the compiled program, in addition to including one or more operators implementing a request-response interface 220, might include one or more other stream processing operators 230 which communicate via a request-response client-side interface with the request-response server-side interface(s) of the one or more request-response stream processing operators 220. Further, the compiled stream processing program may include a request-response client-side interface 240 that is incorporated into (for example) a user-written client application 250, which is separately compiled 260 into a client application 270. When running, client application 270 is thus able to access the one or more request-response stream processing operator(s) 220 via their respective request-response interfaces. The compiled stream processing language program may also include other stream processing operators and other artifacts, such as a deployment specification, etc. 280.

Advantageously, provided herein is a framework for specification and instantiation of stream processing operators that can not only process incoming streaming data, but which also expose an additional request-response interface(s) (i.e., service interfaces) to enable request-response-type invocations of particular methods within the stream processing operator. Addition of such capabilities to a stream processing operator facilitates seamless unification of two distinct distributed programming paradigms, that is, stream-based and request-response-based. Advantages of exposing a request-response interface within a stream processing operator include, providing the ability to modify the stream processing operator's operating behavior, providing flow control, providing operator state retrieval and initialization abilities, as well as more involved operations that utilize an operator's state and processing to construct a response for a given request. These services are generally referred to herein as methods which are implemented by a stream processing operator such as disclosed herein.

Described herein is an approach for specifying and instantiating operators that cannot only process streaming data, but can also respond to requests via service interfaces (i.e., request-response interfaces). The approach disclosed simplifies accessing or modifying a state associated with a stream processing operator by allowing a user to clearly define and declare operator interfaces at the language level. Additionally, since in one embodiment the operator service interfaces and their usages are clearly defined at the stream processing language level, these interfaces and interactions can be easily visualized, which advantageously facilitates manageability of the stream processing application.

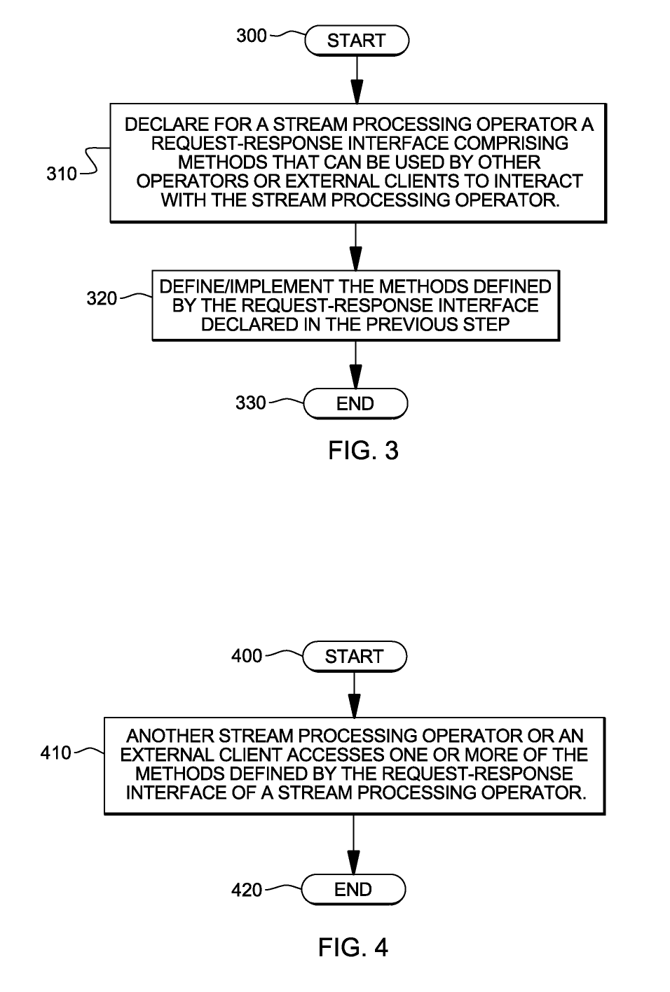

FIG. 3 illustrates one embodiment of a process for declaring and defining a request-response interface as part of a stream processing operator. The process starts 300 with declaring for a stream processing operator a request-response interface which includes one or more methods that can be used by other operators or external clients to interact with the stream processing operator 310. By way of example, declaring relates to specifying the signature of the method or the function. The interface methods can be specified in the stream processing operator definition or in a specific instantiation of the stream processing operator. The declared interface methods are then defined (i.e., the implementation of the declared method or function is specified) 320 for the request-response interface declared in the previous step 310, which completes the declaring and defining process 330.

By way of specific example, the code set out below is an interface declaration and definition in the SPL stream processing language for a stream processing operator entitled SocialNetworkManager, wherein an interface service is provided at the end lines of the code. In this example, the interface service is a GetTopKEdges (int32 k) interface service, wherein the top K edges within the internal social network graph being assembled by the SocialNetworkManager operator are retrieved through the interface, and int32 k is a 32-bit integer taken by the particular interface method.

composite SocialNetworkManager (input I; output O)
{

type

Edge = int32 start, int32 end;
Property = string8 name, blob value;
Network = map<Edge,list<Property>>;

graph

stream<O> O = Functor (I) {

logic

state : Network network;
onTuple I:

// store edge
network[edge] = properties;

service

list<Edge> getTopKEdges (int32 k) {

// implementation

}

}

}

FIG. 4 illustrates a process of using a request-response interface defined as part of a stream processing operator. This process starts 400 with another stream processing operator or an external client application (comprising a request-response client-side interface) accessing one or more methods defined by a request-response interface of a stream processing operator 410. This accessing includes referring to a specific instantiation of the stream processing operator which includes the request-response interface, and to a specific interface method provided by that specific instantiation of the stream processing operator. Upon completion of the access, including any control function, the processing is complete 420. Below is one example of another stream processing operator, which may be processing the same stream of data or another stream of data, accessing the request-response stream processing operator via the request-response interface to obtain, by way of example, the top K edges identified in the internal social network graph maintained by the request-response stream processing operator.

composite Main{

type

Edge = SocialNetworkManager.Edge;
Property = SocialNetworkManager.Property;

graph

stream<Edge edge, list<Property> properties> xedges

= TCPSource( ) { param address: “10.45.67.8”;
port: 12300; }

stream(Edge edge, list<Property> properties> yedges

= UDPSource( ) { param address: “10.45.67.9”;
port: 12301; }

stream<xedges> updatedEdges

= SocialNetworkManager (xedges) { }

stream<yedges> filteredEdges

= Functor (yedges)

{

param filter: find
(SocialNetworkManager.O.getTopKEdges(10), edge) >=0;

}

}

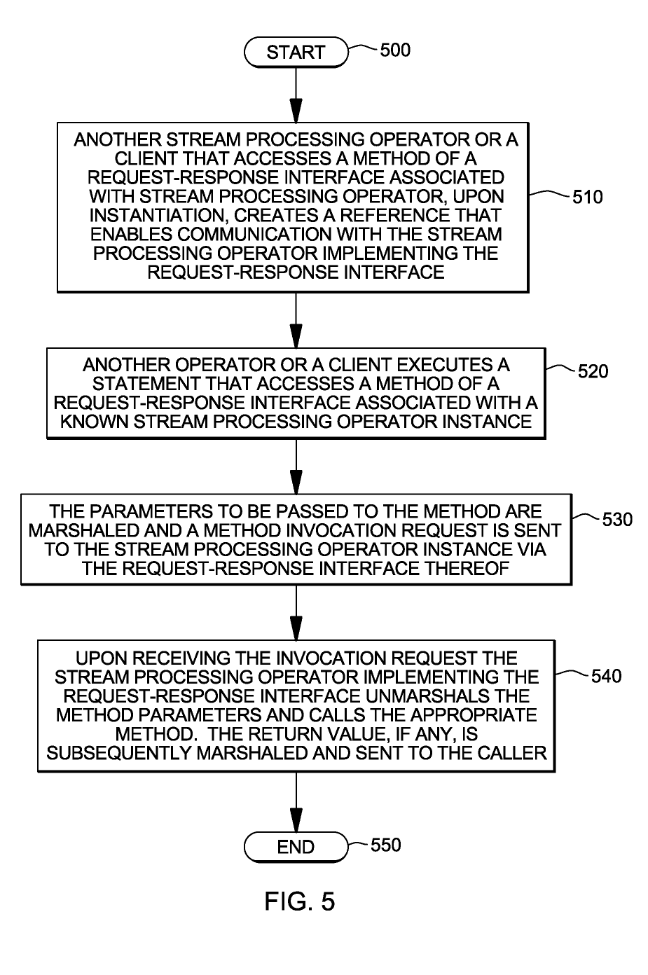

FIG. 5 illustrates one example of request-response processing implemented by a request-response interface integrated as part of a stream processing operator, in accordance with an aspect of the present invention. Processing begins 500 with another stream processing operator or a client application accessing a method of the request-response interface associated with a request-response stream processing operator, creating, upon instantiation, a reference that enables communication with the stream processing operator comprising the request-response interface 510. The another operator or client application subsequently executes a statement that accesses a method of the request-response interface associated with a known stream processing instance of the stream processing operator 520, and parameters to be passed to the method are marshaled and a method invocation request is sent to the stream processing instance via the request-response interface thereof, which is sent via a separate communication path from the streaming data being processed by the stream processing operator 530. Upon receiving the invocation request, the stream processing operator implementing the request-response interface un-marshals the method parameters and calls the appropriate method 540. The return value, if any, is subsequently marshaled and sent to the calling stream processing operator or client application, which completes the processing 550.

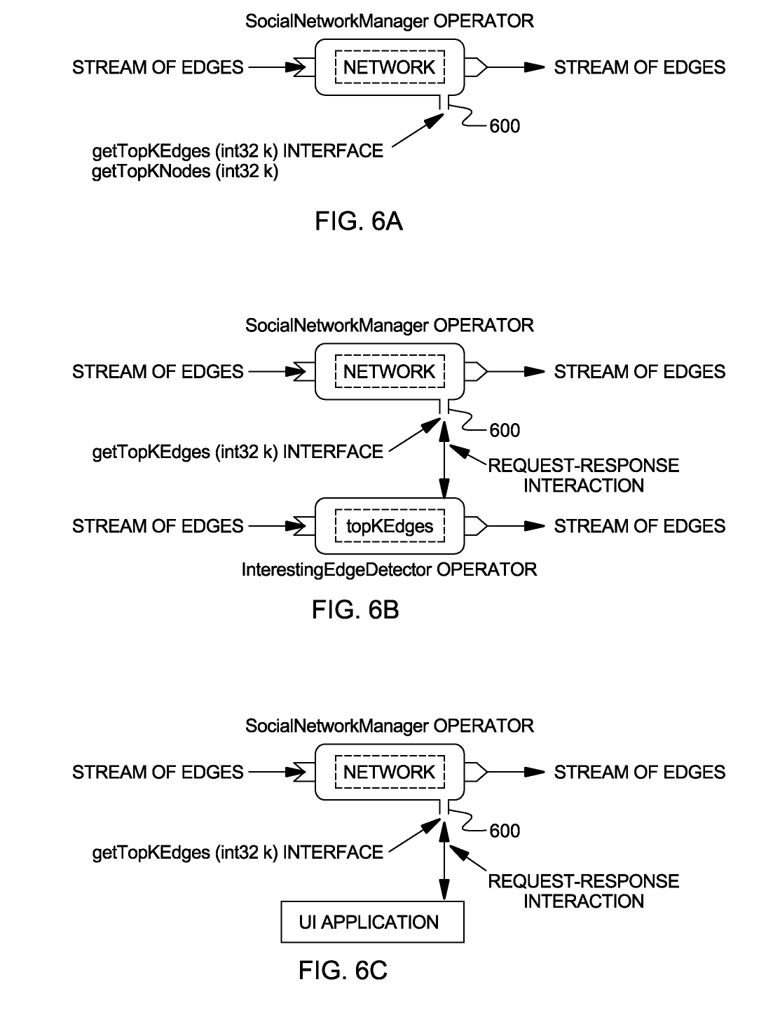

FIG. 6A illustrates one example of a stream processing operator (referred to as a SocialNetworkManager operator) which processes, in this example, a stream of edges, which may comprise communication edges between entities in a social network graph. In this example, the SocialNetworkManager operator is constructing an internal network from identified edges in the stream of edges. The SocialNetworkManager operator is a specific example of a request-response stream processing operator, as the term is used herein, wherein a request-response interface 600 is provided which allows interaction with the SocialNetworkManager operator via a different communication path than the communication path comprising the streaming edges. In this example, multiple methods are provided through the request-response interface. By way of example, GetTopKEdges and GetTopKNodes are two methods which may be accessed through interface 600. The GetTopKEdges method can be used to retrieve a specified number of “top” edges from the network being internally maintained by the SocialNetworkManager operator, while the GetTopKNodes may be used to retrieve a specified number of “top” K connected nodes from the network being internally maintained by this operator.

In FIG. 6B, the SocialNetworkManager operator of FIG. 6A is shown, along with another stream processing operator, referred to as the InterestingEdgeDetector operator, which interacts therewith via the request-response interface 600. Specifically, the InterestingEdgeDetector operator communicates with the SocialNetworkManager operator to call the GetTopKEdges method thereof to ascertain the top K edges being monitored by the SocialNetworkManager operator. Thus, the request-response interface 600 allows access through the predefined internal method(s) of SocialNetworkManager operator to the state of the internal network being maintained by the SocialNetworkManager operator. In the example depicted, the InterestingEdgeDetector operator is also processing streaming edges, which may be the same streaming edges being processed by the SocialNetworkManager operator, or a different stream of edges. The InterestingEdgeDetector operator maintains internally the top K edges identified.

FIG. 6C is analogous to FIG. 6B, except that the interacting is from an external, client application. Specifically, the client application communicates via the request-response interface 600 with the SocialNetworkManager operator to employ, for example, the GetTopKEdges method thereof to identify from the network maintained internally by the SocialNetworkManager operator the top K edges.

Providing stream processing operators which support request-response-type interaction is a significant advancement for the real-time data streaming analytics market. As disclosed herein, a request-response interface is declared and defined as part of a stream processing operator, and which can subsequently be used to interact with the stream processing operator via a communication path separate from the streaming data being processed. In various embodiments, declaring of the request-response interface may be static, which causes the interface to be accessible without an instance of the operator. Declaring the request-response interface to be public, would cause the interface to be accessible by any peer stream processing application. Defining the request-response interface may include defining the interface as part of the stream processing operator body itself, or defining the interface in another language of the user's choice. The request-response interface may be used from another stream processing operator, or from another running application (e.g., a command line-based utility or a GUI-based application).

The request-response interface (and the defined methods thereof) may be employed, for example, to access a control state of an operator. For example, a threshold associated with a filter operator may be modified through a request-response interface as proposed herein (e.g., operator.setThreshold (5.5)). In addition, the request-response interface may be employed to interact (e.g., access, manipulate, etc.) with a logical state of a stream processing operator. For example, retrieving the top K-most connected nodes from a network graph being maintained internally by an operator (e.g., operator.getTopKNodes (10)).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

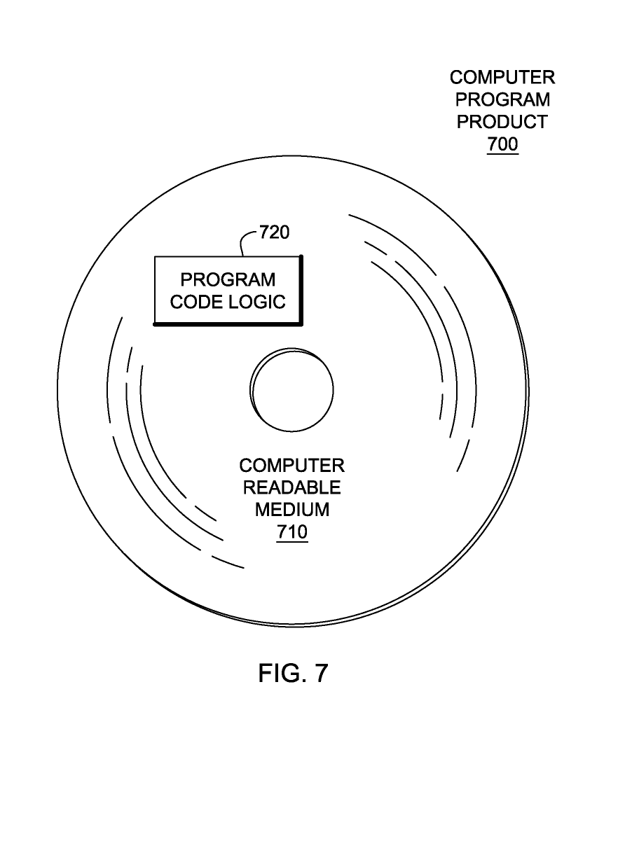

Referring now to FIG. 7, in one example, a computer program product 700 includes, for instance, one or more computer readable storage media 710 to store computer readable program code means or logic 720 thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

Although various embodiments are described above, these are only examples. For example, other platforms and/or languages can be used without departing from the spirit of the present invention. Aspects of the invention may be performed by tools other than those described herein. Moreover, for certain steps or logic performed by a compiler, other preprocessors or preprocessing logic can be used. Therefore, the term “preprocessor” includes a compiler, any other preprocessor or preprocessor logic, and/or any type of logic that performs similar functions.

Further, other types of computing environments can benefit from one or more aspects of the present invention. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the present invention, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiment with various modifications as are suited to the particular use contemplated.

What is claimed is:

1. A method of processing streaming data in a data processing system, the method comprising:
defining, by a processor, a request-response interface as part of a stream processing operator defined using a stream processing language, wherein the stream processing operator is a processing component that processes a data stream as continuously received, and the request-response interface is a non-streaming interface;
processing a stream of data using the stream processing operator with the request-response interface defined as a part thereof; and
communicating with the stream processing operator through the request-response interface via a communication path separate from the stream of data, the communicating at least one of accessing or controlling a state of the stream processing operator while the stream processing operator is processing the stream of data.

2. The method of claim 1, wherein the defining comprises defining the request-response interface as part of a definition of the stream processing operator.

3. The method of claim 1, wherein the defining comprises defining the request-response interface as part of a specific instantiation of the stream processing operator.

4. The method of claim 1, wherein the defining comprises declaring and defining in the stream processing language the request-response interface as part of the stream processing operator.

5. The method of claim 1, wherein the communicating comprises another stream processing operator of the data processing system interacting with the stream processing operator through the request-response interface of the stream processing operator while the stream processing operator is processing the stream of data.

6. The method of claim 1, wherein the communicating comprises a running application of the data processing system interacting with the stream processing operator through the request-response interface of the stream processing operator while the stream processing operator is processing the stream of data.

7. The method of claim 1, wherein the communicating with the stream processing operator through the request-response interface thereof comprises interacting with the stream processing operator to modify the state of the stream processing operator while the stream processing operator is processing the stream of data.

8. The method of claim 1, wherein the state is an internal control state of the stream processing operator which is at least one of accessed or controlled while the stream processing operator is processing the stream of data.

9. The method of claim 1, wherein the state is an internal logical state of the stream processing operator which is at least one of accessed or controlled while the stream processing operator is processing the stream of data.

10. A computer program product for processing streaming data in a data processing system, the computer program product comprising:
a computer readable storage medium for execution by at least one processor for performing:
defining, by the at least one processor, a request-response interface as part of a stream processing operator defined using a stream processing language, wherein the stream processing operator is a processing component that processes a data stream as continuously received, and the request-response interface is a non-streaming interface;
processing a stream of data using the stream processing operator with the request-response interface defined as a part thereof; and
communicating with the stream processing operator through the request-response interface via a communication path separate from the stream of data, the communicating at least one of accessing or controlling a state of the stream processing operator while the stream processing operator is processing the stream of data.

11. The computer program product of claim 10, wherein the defining comprises defining the request-response interface as part of a definition of the stream processing operator.

12. The computer program product of claim 10, wherein the defining comprises defining the request-response interface as part of a specific instantiation of a stream processing operator.

13. The computer program product of claim 10, wherein the defining comprises declaring and defining in the stream processing language the request-response interface as part of the stream processing operator.

14. The computer program product of claim 10, wherein the communicating comprises another stream processing operator or a running application of the data processing system interacting with the stream processing operator through the request-response interface of the stream processing operator while the stream processing operator is processing the stream of data.

15. The computer program product of claim 10, wherein the communicating with the stream processing operator through the request-response interface thereof comprises interacting with the stream processing operator to modify the state of the stream processing operator while the stream processing operator is processing the stream of data.

16. The computer program product of claim 10, wherein the state is an internal control state or an internal logic state of the stream processing operator which is at least one of accessed or controlled while the stream processing operator is processing the stream of data.

17. A computer system for processing streaming data, the computer system comprising:
a processor to process a stream of data using a stream processing operator with a request-response interface defined as a part thereof, wherein the stream processing operator is a processing component that processes a data stream as continuously received, and the request-response interface is a non-streaming interface; and
wherein another stream processing operator or a running application communicates with the stream processing operator through the request-response interface via a communication path separate from the stream of data, the communicating at least one of accessing or controlling a state of the stream processing operator while the stream processing operator is processing the stream of data.

18. The computer system of claim 17, wherein the processor defines the request-response interface as part of a definition of the stream processing operator or as part of a specific instantiation of the stream processing operator.

19. The computer system of claim 17, wherein the processor defines and declares the request-response interface in the stream processing language of the stream processing operator.

20. The computer system of claim 17, wherein the another stream processing operator or running application communicates with the stream processing operator through the request-response interface to modify one of a control state or a logical state of the stream processing operator while the stream processing operator is processing the stream of data.
